(19) United States
(12) Patent Application Publication
(10) Pub. No.: US 2004/0130982 A1
(43) Pub. Date: Jul. 8, 2004

(54) Method of controlling recording operation for optical disc recording apparatus

(75) Inventors: Jong-hoon Lee, Suwon-si (KR); Ki-bong Yun, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/645,868

(22) Filed: Aug. 22, 2003

(30) Foreign Application Priority Data
Sep. 6, 2002 (KR) 2002-53813

(51) Int. Cl. G11B 7/095

(52) U.S. Cl. 369/44.32; 369/53.15

(57) ABSTRACT

A method of controlling a recording operation for an optical disc recording apparatus classifies a defect in a disc based on an extent to which the defect has an influence on the recording operation and controls the recording operation therewith. The defect is classified into a first category, indicating that data based on a length thereof, is recordable and a second category indicating that the data is not reproducible even though the data is recordable. If the defect is detected, the data is recorded while a servo unit maintains a servo-tracking by a previous servo control value and a defect type is determined. If the defect corresponds to the first category, the data is assumed to be recorded in a defect region and recording data is continued. If the defect corresponds to the second category, the data recorded in the defect region is recorded in another region.

### CROSS-REFERENCE TO RELATED APPLICATIONS

This application claims the priority of Korean Patent Application No. 2002-53813, filed on Sep. 6, 2002, in the Korean Intellectual Property Office, the disclosure of which is incorporated herein by reference.

### BACKGROUND OF THE INVENTION

1. Field of the Invention

The present invention relates to a method of controlling a recording operation for an optical disc recording apparatus, and more particularly, to a method of controlling a recording operation wherein defects in a disc are classified based on effects of the defects on the recording operation and the recording operation is controlled according to the classified defects.

2. Description of the Related Art

Data is read from or recorded to an optical disc such as a compact disc (CD) or a digital video disc (DVD) in a contactless manner by using an optical pick-up device.

In general, the optical disc used in data reading and data recording operations in an optical disc recording apparatus has pits and lands corresponding to signals to be recorded on a surface along a spiral track thereof. The recorded signals in a form of the pits and lands are read as electrical signals by the optical pick-up device of the optical disc reproducing apparatus and are demodulated into video signals or audio signals by a demodulating circuit. The optical pick-up device radiates a laser beam to a disc surface through an objective lens and outputs a light reflected from a reflection film on the disc surface as the electrical signals by using a photo sensor.

FIG. 1 is a block diagram showing a configuration of a conventional optical disc reproducing apparatus including a defect detecting device. Referring to FIG. 1 an optical pick-up device 104 generates an electrical signal (i.e., a reproduction signal) corresponding to a pit and a land recorded in an optical disc 100. A reproduction signal processing unit 106 amplifies the reproduction signal generated from the optical pick-up device 104 to a predetermined amplification level, outputs the amplified reproduction signal, and detects a servo error signal used to control servos according to the reproduction signal. A digital signal processing unit 110 obtains a digital signal from the reproduction signal generated from the optical pick-up device 104 and reproduces data recorded in the optical disc 100. A spindle motor 102 rotates the optical disc 100, and a servo unit 114 controls a tracking servo, a focus servo and a slide servo in response to the servo error signal processed by the reproduction signal processing unit 106.

A defect detection unit 108 detects a defect on the optical disc 100 by using the reproduction signal processed by the reproduction signal processing unit 106 and generates a defect detection signal when the defect is detected. The defect detection unit 108 detects the defect by comparing the reproduction signal processed by the reproduction signal processing unit 106 with a predetermined threshold.

FIG. 2 is a block diagram showing an example of a defect detecting circuit of FIG. 1, and FIGS. 3A-3F are waveforms showing an operation of the defect detecting circuit of FIG. 2. A first comparator 200 of FIG. 2 receives a reproduction signal RF shown in FIG. 3A to a positive input terminal thereof, receives a first comparison voltage Vthp to a negative input terminal thereof, and compares the reproduction signal RF and the first comparison voltage Vthp. The first comparator 200 generates a first comparison signal which is at a high logic level when the reproduction signal RF is higher than the first comparison voltage Vthp as shown in FIG. 3B and which is at a low logic level when the reproduction signal RF is lower than the first comparison voltage Vthp.

A second comparator 202 receives a second comparison voltage Vthn to a positive input terminal thereof, receives the reproduction signal RF as shown in FIG. 3A to a negative terminal thereof, compares the second comparison voltage Vthn and the reproduction signal RF, and generates a second comparison signal which is at the high logic level when the reproduction signal RF is lower than the second comparison signal and which is at the low logic level when the reproduction signal RF is higher than the second comparison signal.

A first delayer 204 receives the first comparison signal outputted from the first comparator 200, maintains the first comparison signal at a same high logic level by delaying the first comparison signal for a predetermined delay time Td defined by a microprocessor 112, shown in FIG. 1, if the first comparison signal is at the high logic level, and outputs a signal as shown in FIG. 3D. A second delayer 206 receives the second comparison signal outputted from the second comparator 202, maintains the second comparison signal at the same high logic level by delaying the second comparison signal for the predetermined delay time Td defined by the microprocessor 112 if the second comparison signal is at the high logic level, and outputs a signal as shown in FIG. 3E. As a result, the first delayer 204 and the second delayer 206 generate the signals which are at the high logic level if the first comparator 200 and the second comparator 202 generate the signals which are at the high logic level for the predetermined delay time Td defined by the microprocessor 112. If the reproduction signal RF is normally generated, even when the first comparator 200 and the second comparator 202 output the signals which are at the low logic level. However, if the first comparator 200 and the second comparator 202 do not generate signals which are at the high logic level after the predetermined delay time Td has passed, that is, if the reproduction signal RF is not normally generated due to a defect, the first comparator 200 and the second comparator 202 generate signals which are at the logic level low which indicate that a detect is on the optical disc 100.

An AND gate 208 outputs the defect detection signal as shown in FIG. 3F by receiving output signals of the first delayer 204 and the second delayer 206 and performing an AND operation on the output signals.

FIG. 4 is a block diagram showing a configuration of a conventional device for controlling a recording operation. A recording modulation unit 418 modulates data to be recorded by using a non return to zero inverted (NRZI) signal and outputs the modulated data. A recording signal processing unit 416 generates a recording pulse corresponding to the NRZI signal and provides an optical pick-up device 404 with the recording pulse. When an optical disc 400 is a phase-change disc, the recording pulse is a multiple pulse array including a first pulse, a last pulse and a multi-pulse array. The recording pulse generates a laser signal by driving a laser diode (not shown) included in the optical pick-up device 404, and data is recorded in the optical disc 400 by the laser signal. The optical pick-up device 404 records data in the optical disc 400 and reads data recorded in the optical disc 400 to provide a reproduction signal processing unit 406 with the data. The reproduction signal processing unit 406 amplifies a reproduction signal generated from the optical pick-up device 404 to a predetermined amplification level, outputs the amplified reproduction signal, and detects a servo error signal used to control servos according to the reproduction signal. A spindle motor 402 rotates the optical disc 400, and a servo unit 414 controls a servo-tracking, a focus servo, a slide servo of the optical pick-up device 404 in response to the servo error signal processed by the reproduction signal processing unit 406.

A defect detection unit 408 is configured as shown in FIG. 2 and generates the defect detection signal which indicates whether there is a defect on the optical disc 400 by using the reproduction signal processed by the reproduction signal processing unit 406.

A microprocessor 412 controls a recording operation of the recording signal processing unit 416. The microprocessor 412 outputs a servo hold signal to the servo unit 414 if the defect occurs during the recording operation and controls the servo unit 414 to perform a servo operation in response to the previous servo error signal which is used before the defect occurs while continuously controlling the data to be recorded in the optical disc 400.

That is, since obtaining a normal servo error signal in a defect region is difficult, the recording operation is performed while the servo unit 414 stably performs the servo operation by the previous servo error signal which is used before the defect occurs.

The microprocessor 412 controls the servo unit 414 such that the servo unit 414 normally performs the servo operation in response to a servo error signal processed by the reproduction signal processing unit 406 after the optical pick-up device 404 moves to another region of the optical disc 400 from the defect region of the optical disc 400.

However, the conventional device to control a recording operation continues performing a servo hold operation regardless of a length of the defect. Thus, if the defect is long, servo-tracking errors such as skipping, sticking, or off-tracking may occur, which cause an abnormal recording operation.

That is, if the defect is long, a difference between a maintained tracking error value and a real tracking error value becomes greater even when the servo unit 414 performs the servo-tracking in response to the previous servo error signal which is used before the defect occurs, thus a tracking operation is not normally performed. Thus, the optical pick-up device 404 may skip, stick, or be off track, which causes the abnormal recording operation.

Defect on the optical disc such as particles of dust, particles of dirt, fingerprints, scratches, or manufacturing defects cause, for example, data errors or servo errors in a reproducing operation. In particular, the defects prevent data from being normally recorded to the optical disc in the recording operation.

Therefore, the recording operation needs to be effectively managed in a region of the optical disc having a defect.

In a case of a DVD such as digital video disc random access memory (DVD-RAM) and a digital video disc rewritable (DVD-RW), a user detects the defect region before using the optical disc, records the detected defect region to a disc management region, and refers to the disc management region when performing the subsequent recording or reproducing operation. That is, the user detects the defect region over a whole region of the optical disc by testing the optical disc such that every sector of the DVD-RAM, or every error correction code (ECC) block of the DVD-RW is tested before using the optical disc. When data is recorded to the tested optical disc, data recording to the detected defect region can be avoided.

In a case of a recordable CD such as a compact disc rewritable (CD-RW) or a compact disc rewriteable+(CD-RW+), to detect a defect every time the recording operation is performed is necessary and to control the recording operation with respect to the detected defect is necessary because the optical disc has no regulations with respect to defect management in contrast to that of the DVD.

However, in a case of a recordable DVD, defects occurring after testing have to be detected every time data is recorded similar that of the recordable CD, and the recording operation has to be controlled with respect to the detected defect.

Thus, in a conventional optical disc recording apparatus, the recording operation is performed while a servo, especially, a servo-tracking, maintains a previous tracking control value which is used before the defect occurs (servo hold).

However, in a conventional method of controlling the recording operation, if a length of the defect is too long, tracking is seriously affected. Thus, a pick-up can skip backward or skip forward, stick, or be off track, which causes an abnormal recording operation.

### SUMMARY OF THE INVENTION

The present invention provides a method of controlling a recording operation of an optical disc recording apparatus which controls the recording operation in accordance with a length of a defect occurring during the recording operation.

According to an aspect of the present invention, a method of controlling a recording operation of an optical disc recording apparatus is provided which records data to a recordable optical disc having a defect, the method comprising, based on a length of the defect, classifying the defect into a first defect category indicating that the data is normally recordable and a second defect category indicating that the data is not normally reproducible even though the data is normally recordable, detecting the defect while recording the data to the recordable optical disc, if the defect is detected, continuing recording of the data in the recordable disc while controlling a servo unit to hold a servo tracking by using a previous servo control value which is used before the defect occurs, determining the length of the defect and a type of the defect based on the length of the defect, and as a result of a determination, if the defect corresponds to the first defect category, assuming that the data is normally recorded in a defect region and continuing recording data, or if the defect corresponds to the second defect category, recording the data recorded in the defect region in a second region.

The method further comprises classifying the defect into a third defect category indicating that the data is not normally recordable and the defect causes a servo error, as the result of the determination, if the defect corresponds to the third defect category, stopping the recording operation.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a block diagram showing a configuration of a conventional optical disc reproducing apparatus including a defect detecting device;

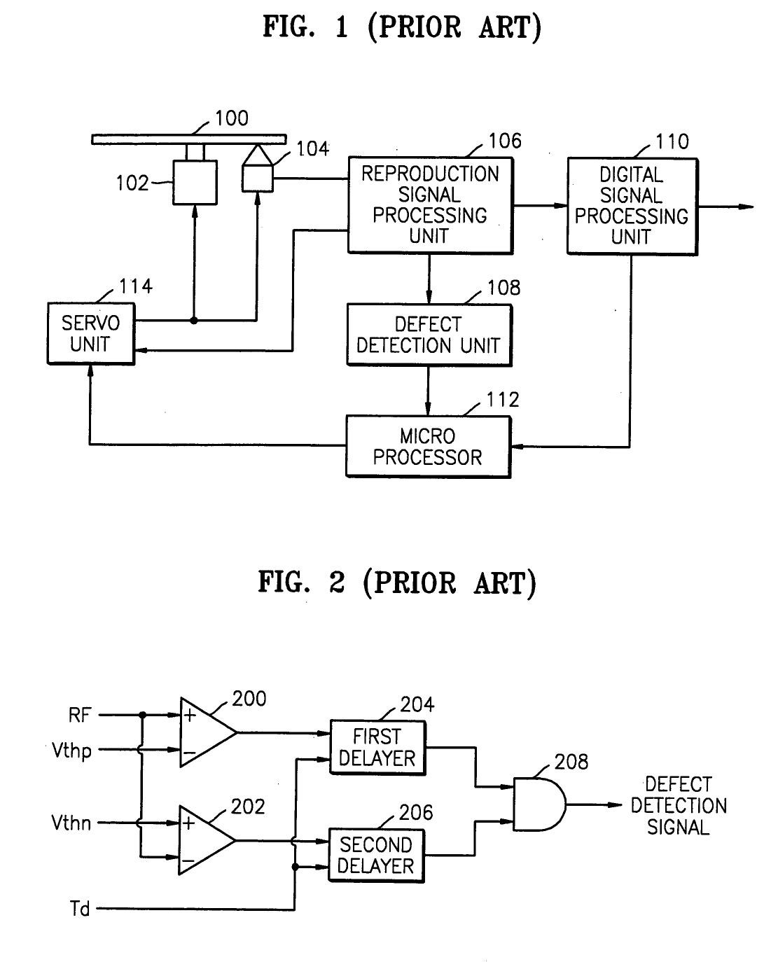

FIG. 2 is a block diagram showing an example of a defect detecting circuit of FIG. 1;

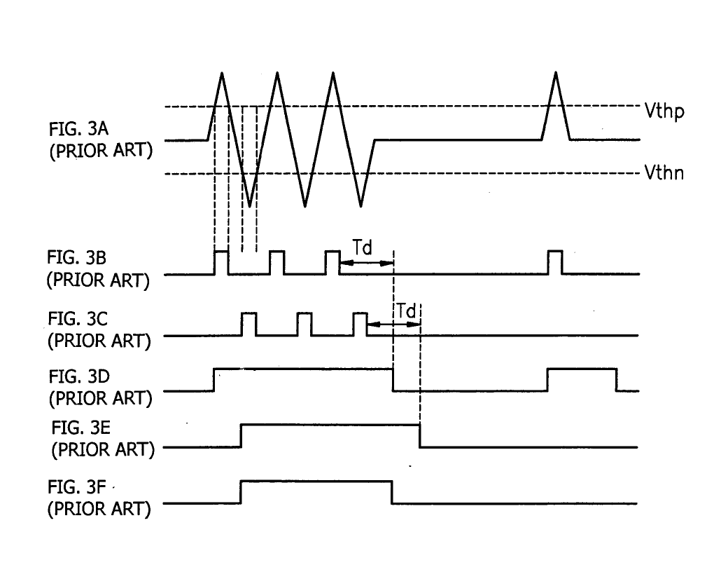

FIGS. 3A through 3F are waveforms showing an operation of the defect detecting circuit of FIG. 2;

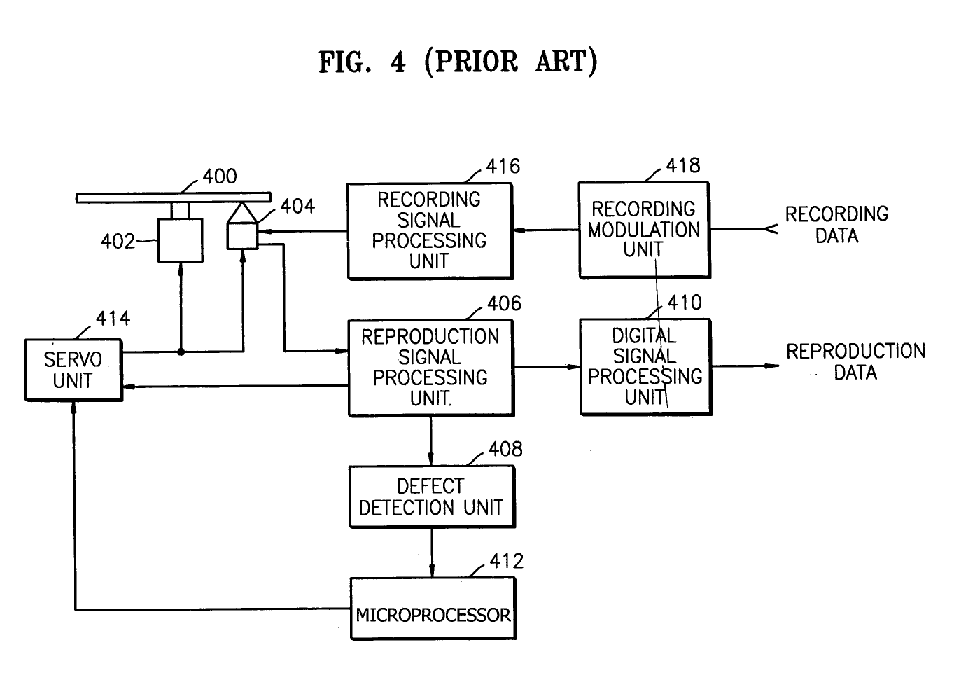

FIG. 4 is a block diagram showing a configuration of a conventional device for controlling a recording operation;

FIG. 5 is a flowchart showing a method of controlling a recording operation according to an embodiment of the present invention;

FIG. 6 is a block diagram showing a configuration of a device suitable for executing a method of controlling a recording operation according to the embodiment of the present invention; and

FIGS. 7A through 7G are waveforms to explain a method of controlling a recording operation of an optical disc recording apparatus in accordance with a type of a defect according to the embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

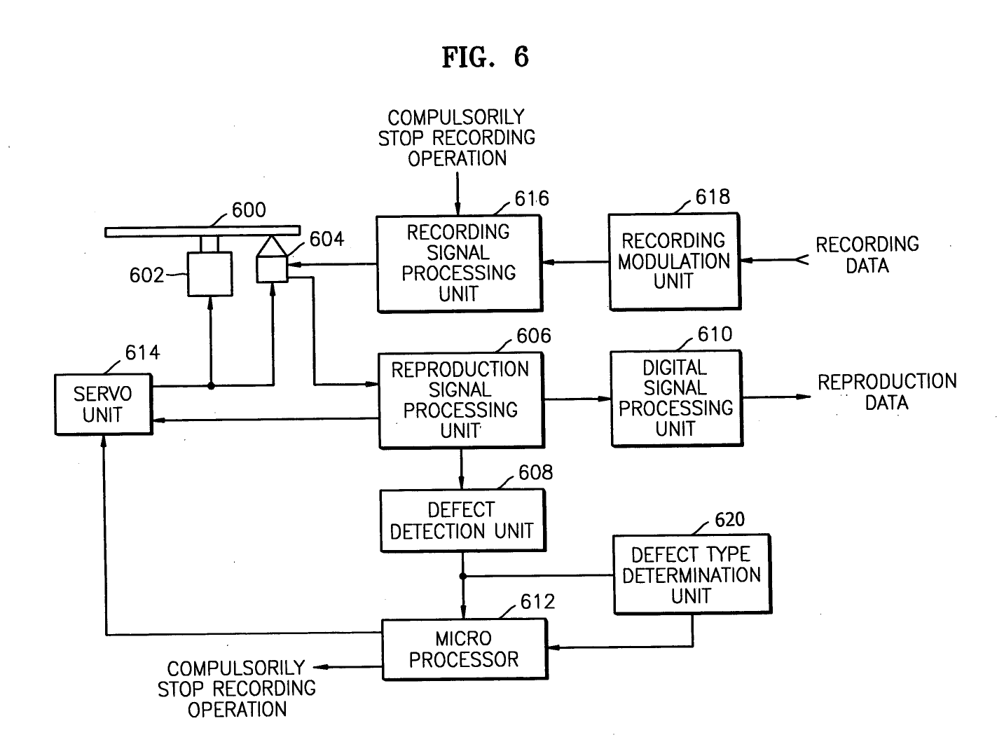

FIG. 5 is a flowchart showing a method of controlling a recording operation according to an embodiment of the present invention.

A defect is classified based on a length thereof in operation S500. For example, if the length of the defect is T, the defect is classifiable as follows:

First defect category (Defect A): T<T1: A defect in which a servo status is stable, and data is readable without any additional operation after the data is recorded;

Second defect category (Defect B): T1<T<T2: A defect in which a servo status is stable, but errors may occur when data is read after the data is recorded; and

Third defect category (Defect C): T2<T: A defect in which a servo status is unstable because the length of the defect is too long, and thus errors may occur.

The servo status indicates a status during the servo hold operation, that is, a status when a tracking operation is maintained by the previous tracking error value which is used before the defect occurs. In addition, T1 indicates the length of the defect where the servo status is stable, and data is readable without any additional operation after being recorded. T2 indicates the length of the detect where the servo status is stable, but errors possibly occur when data is read after being recorded. T1 and T2 are variable according to, for example, a recording speed, a specification of the servo unit 414. Thus, T1 and T2 may be determined for each product.

The defect is detected while data is recorded in an optical disc in operation S502.

If the defect is determined to be on the optical disc as a result of a determination in operation S502, data is recorded while a servo unit maintains a servo hold status, that is, a previous status of the servo unit before the defect occurs in operation S504.

A type of the defect is determined in operation S506. The length of the defect is an interval starting when the defect occurs until the defect disappears.

A recording operation is controlled in accordance with the type of the defect in operation S508.

For example, if the defect corresponds to the first defect category (Defect A), the data is assume to be normally recorded even in a defect region of the optical disc, thus the data is continuously recorded without any additional operation.

If the defect corresponds to the second defect category (Defect B), the data is recorded again in another region of the optical disc because correcting errors of the data recorded in the defect region is not possible.

If the defect corresponds to the third defect category (Defect C), the recording operation is compulsorily stopped because further recording of the data is not possible because of detracking (i.e., tracking errors).

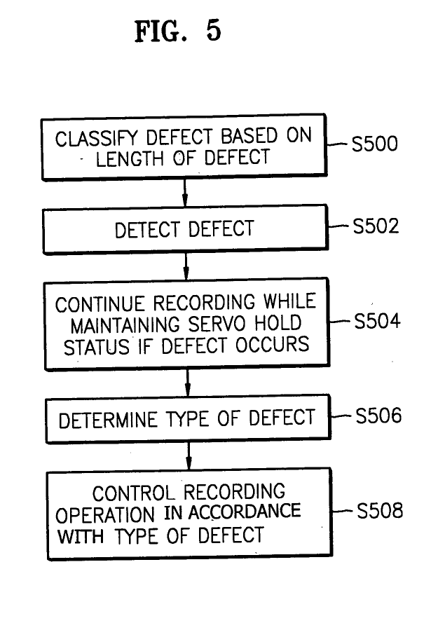

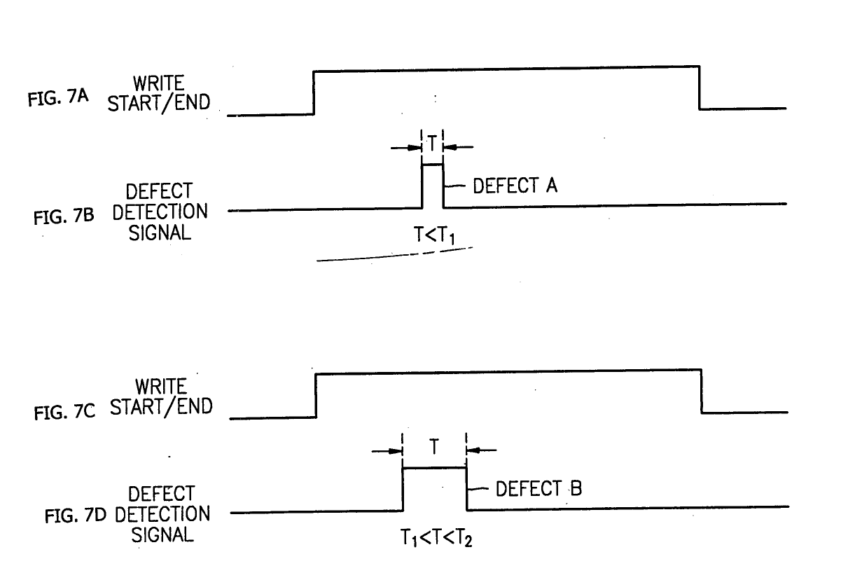

FIG. 6 is a block diagram showing a configuration of a device suitable to execute a method of controlling a recording operation according to the embodiment of the present invention. Since elements referred to as reference numerals 600 through 614 in FIG. 6 operate in a common manner as the elements referred to as reference numerals 400 through 414, respectively, in FIG. 4, operations of the elements 600 through 614 will not be described.

A defect type determination unit 620 determines a type of a defect with reference to a defect detection signal provided from a defect detection unit 608. The defect type determination unit 620 determines the type of the defect from among the first to the third defect categories (Defect A, Defect B and Defect C) by performing an operation corresponding to operation S504 of FIG. 5.

The first defect category (Defect A) denotes a defect in which a servo status is stable, and data is readable without any additional operation after the data is recorded. The second defect category (Defect B) denotes a defect in which the servo status is stable, but errors possibly occur when data is read after the data is recorded. The third defect category (Defect C) denotes a defect in which the servo status is unstable because the length of the defect is too long, and thus errors possibly occur.

A determination result of the defect type determination unit 616 is provided to a microprocessor 612. The microprocessor 612 controls the recording operation based on the determination result of the defect type determination unit 616.

More specifically, the microprocessor 612 controls the recording operation such that the data is continuously recorded without any additional operation if the defect corresponds to the first defect category (Defect A). If the defect corresponds to the second defect category (Defect B), the microprocessor 612 controls the recording operation such that the data is recorded again in another region because to correct errors is not possible. If the defect corresponds to the third defect category (Defect C), the microprocessor 612 controls to the recording operation such that the recording operation is compulsorily stopped.

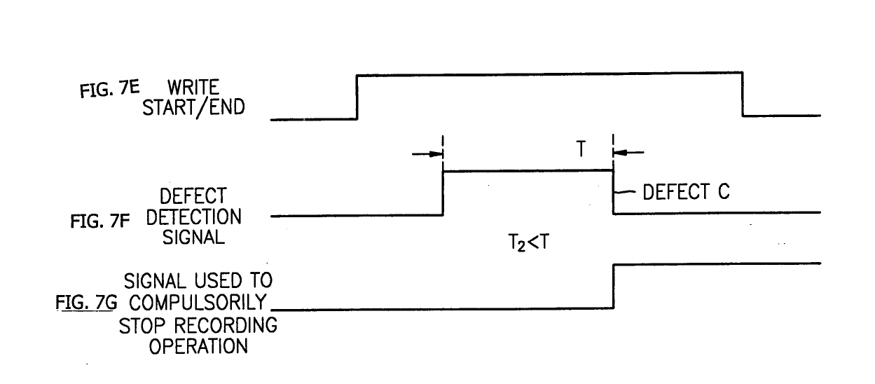

FIGS. 7A to 7G are waveforms to explain a method of controlling a recording operation of an optical disc recording apparatus in accordance with a type of a defect.

FIGS. 7A to 7B present waveforms showing a case when the defect occurring in an optical disc corresponds to the first defect category (Defect A), that is, a length T of the defect is smaller than the length T1 where the servo status is stable, and data is continuously recorded without any additional operation. When the defect corresponds to the first defect category (Defect A), even data recorded in the defect region is processed by another operation because errors are assumed not to occur when the data is read after being recorded.

FIGS. 7C to 7D present waveforms showing a case when the defect occurring in the disc corresponds to the second defect category (Defect B), that is, the length T of the defect is greater than the length T1 where the servo status is stable, and data is continuously recorded without any additional operation, and is smaller than a length T2 where the servo status is stable, but errors possibly occur when the data is read after being recorded. When the defect corresponds to the second defect category (Defect B), correcting errors when the data recorded in the defect region is read is not possible, and thus the data is recorded in another region.

FIGS. 7F to 7G present waveforms showing a case when the defect occurring in the disc corresponds to the third defect category (Defect C), that is, the length T of the defect is greater than the length T2 where the servo status is stable, but errors possibly occur when the data is read after being recorded. When the defect corresponds to the third-defect category (Defect C), off-tracking may occur, and thus the recording operation is compulsorily stopped.

As is described above, a method of controlling a recording operation of an optical disc recording apparatus prevents off-tracking due to a defect of long length from occurring and data from being recorded in a defect region from which reading the data is not possible.

In addition, according to the method of controlling a recording operation of the optical disc recording apparatus, processing the defect every time when a new defect occurs is possible. Thus, managing the defect in a rewritable disc is easy.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of controlling a recording operation of an optical disc recording apparatus which records data to a recordable optical disc having a defect, the method comprising:
based on a length of the defect, classifying the defect into a first category indicating that the data is normally recordable and a second category indicating that the data is not normally reproducible even though the data is normally recordable;
detecting the defect while recording the data to the recordable optical disc;
if the defect is detected, continuing recording of the data in the recordable disc while controlling a servo unit to hold a servo tracking by using a previous servo control value which is used before the defect occurs;
determining the length of the defect and a type of the defect based on the length of the defect; and
as a result of the determining, if the defect corresponds to the first category, assuming that the data is normally recorded in a defect region and continuing recording of the data, or if the defect corresponds to the second category, further recording of the data recorded in the defect region in another region.

2. The method of claim 1, further comprising:
classifying the defect into a third category indicating that the data cannot be normally recorded and the defect causes a servo error;
as a result of the determining, if the defect corresponds to the third category, stopping the recording operation.

3. The method of claim 1, wherein the recordable optical disc is a recordable compact disc.

4. The method of claim 1, wherein the recordable optical disc is a recordable digital video disc.

5. A method of controlling a recording operation of an optical disc recording apparatus which records data to a recordable optical disc having a defective region, comprising:
detecting the defective region of the recordable optical disc;
determining a length of the defective region, while recording the data to the recordable optical disc;
controlling a servo unit based on a value of a servo control just prior to a detection of the defective region if recording the data to the defective region;
classifying the defective region into a first category in which the data is recordable in the defective region and into a second category in which the data is not reproducible from the defective region even though the data is recordable therein, according to the length of the defective region; and
if a classified result is in the first category, recording the data in the defective region or if the classified result is in the second category, recording the data in a second region of the optical recordable disc.

6. The method of claim 5, further comprising:
classifying the defective region into a third category in which the data cannot be recorded; and
if the classified result is in the third category, stopping the recording operation.

7. The method of claim 5, wherein the recordable optical disc is one of a recordable compact disc and a recordable digital video disc.

8. An optical disc recording apparatus which records data to a recordable optical disc having a defect, comprising:
an optical pickup generating a reproduction signal;
one or more servos to move the optical pickup;
a processing unit to detect a servo error signal from the reproduction signal and to control the one or more servos according to the reproduction signal;
a defect detection unit to detect a defect on the optical disc and to generate a defect detection signal when the defect is detected; and
a defect type determination unit to determine a type of the defect with reference to the defect detection signal provided from the defect detection unit based on a length of a defective region of the defect.

9. The apparatus of claim 8, wherein the type of the defect is determined by the defect type determination unit based on whether the data is recordable in the defective region or the data is not reproducible from the defective region even though the data is recordable therein.

10. The apparatus of claim 9, wherein the type of the defect is further determined by the defect type determination unit based on whether the data cannot be recorded in the defective region.

11. The apparatus of claim 10, wherein the recordable optical disc is one of a recordable compact disc and a recordable digital video disc.

12. A program executed by a processor to record data to a recordable optical disc having a defective region by:
detecting the defective region of the recordable optical disc;
determining a length of the defective region, while recording the data to the recordable optical disc;
controlling a servo unit based on a value of a servo control just prior to a detection of the defective region if recording the data to the defective region;
classifying the defective region into a first and category in which the data is recordable in the defective region and a second category in which the data is not reproducible from the defective region even though the data is recordable therein, according to a length of the defective region; and
if the classified result is in the first category, recording the data in the defective region or if the classified result is in the second category, recording the data in a second region of the optical recordable disc.

13. A method of controlling a recording operation of an optical disc recording apparatus which records data to a recordable optical disc having a defective region, the method comprising:
detecting the defective region of the recordable optical disc;
determining a length of the defective region, while recording the data to the recordable optical disc;
controlling a servo unit based on a value of a servo control just prior to a detection of the defective region, if recording the data to the defective region;
classifying the defective region into a first category, if the length of the defective region is less than a first reference length and into a second category, if the length of the defective region is between the first reference length and a second reference length; and
if a classified result is in the first category, recording the data in the defective region or if the classified result is in the second category, recording the data in a second region of the optical recordable disc.

14. The method of claim 13, wherein the first reference length is a maximum length of the defective region where a servo status is stable and data is readable without any additional operation of the optical disc recording apparatus after data is recorded.

15. The method of claim 13, wherein the second reference length is a maximum length of the defective region where a servo status is stable, but errors occur when the data is read after being recorded.

16. An optical disc recording apparatus which records data to a recordable optical disc having a defect, comprising:
an optical pickup generating a reproduction signal;
one or more servos to move the optical pickup;
a processing unit to detect a servo error signal from the reproduction signal and to control the one or more servos according to the reproduction signal;
a defect detection unit to detect a defect on the optical disc and to generate a defect detection signal when the defect is detected; and
a defect type determination unit to determine a type of the defect with reference to the defect detection signal provided from the defect detection unit based on whether the defective region is greater than a reference length.

17. The apparatus of claim 16, wherein the reference length is a maximum length of the defective region where a servo status is stable and data is readable without any additional operation of the optical disc recording apparatus after data is recorded.

18. The apparatus of claim 16, wherein the defect type determination unit further determines whether the defective region is greater than a second reference length, and stops the recording of the data if the defective region is determined to be greater than the second reference length.

19. The apparatus of claim 18, wherein the second reference length is a maximum length of the defective region where a servo status is stable, but errors occur when the data is read after being recorded.
